(19) United States
(12) Patent Application Publication
(10) Pub. No.: US 2010/0215054 A1
(43) Pub. Date: Aug. 26, 2010

(54) MAINTAINING A CONSTANT DELAY IN POINT-TO-POINT TRANSMISSION

(75) Inventor: Gaby Yakov, Nes Ziona (IL)

Correspondence Address: MARTIN D. MOYNIHAN d/b/a PRTSI, INC., P.O. BOX 16446, ARLINGTON, VA, 22215, US

(73) Assignee: CERAGON NETWORKS LTD., Tel-Aviv (IL)

(21) Appl. No.: 12/678,527

(22) PCT Filed: Sep. 23, 2008
(86) PCT No.: PCT/IL2008/001273

§ 371 Date: Mar. 17, 2010

Related U.S. Application Data
(60) Provisional application No. 60/960,289, filed on Sep. 24, 2007.

(51) Int. Cl. H04L 29/02

(52) U.S. Cl. 370/468; 375/259

(57) ABSTRACT

A system configured to transmit data at a variable transmission rate over a point-to-point link, while maintaining a substantially constant transmission delay over the point-to-point link, including a transmitter configured to add an indication of a transmission rate to the data being transmitted and to transmit the indication of the transmission rate along with the data, and a receiver configured to receive an indication of a transmission rate along with data and to read the indication of the transmission rate and including a delay compensation buffer. Related apparatus and methods are also described.

### FIELD OF THE INVENTION

The present invention relates to a system and method for maintaining a substantially constant delay, over changing transmission data rates, between input and output of a point-to-point transmission, and, more particularly but not exclusively, to receiver-side delay management.

### BACKGROUND OF THE INVENTION

Point-to-point transmissions often utilize as much transmission data rate as possible, squeezing maximum use out of the hardware installed. Some point-to-point transmission technologies can be affected by changing conditions, and the maximum transmission data rate possible can change over time. Some examples of such technologies are point-to-point radio links, point-to-point Infrared links, wireless links where at least one of the nodes is moving, and so on.

When the maximum transmission data rate is affected, some point-to-point transmission technologies make a corresponding change in their transmission data rate, thereby transmitting less data per unit of time. Other point-to-point transmission technologies simply fail to provide point-to-point communication.

In some point-to-point transmission protocols, such as Ethernet, there is usually little concern as to how much delay is introduced between sending data and receiving it, as long as the delay is within reasonable limits. If the delay changes over time, and remains under a reasonable limit, that is acceptable. In other protocols, the change in transmission rate often causes a glitch, or jitter, in applications using the data transmitted over the point-to-point transmission. The change in delay and the jitter are often unacceptable.

One of the causes of the jitter is the fact that a delay between transmission of the data and application of the data is not constant, and the applications rely on a constant delay. Non-limiting example applications which require a substantially constant delay are voice telephony, live video transmissions, Time Division Multiplexing (TDM) type communications, such as an E1/T1 network, a PDH (Plesiochronous Digital Hierarchy) network, a SONET network, an SDH network (Synchronous Digital Hierarchy), and so on.

US Published Patent Application 2006/0077994 of Spindola et al describes systems and methods for adapting a de jitter buffer to conform to air link conditions. An air link characteristic may be detected before that characteristic begins to affect packet delivery, such as by slowing or speeding delivery delay at a subscriber station. A receiver-side de jitter buffer, which adds delay to received packets, may adaptively adjust its size based upon the detected air link characteristic, such that the de jitter buffer is appropriately sized for anticipated data packets before they are received at the subscriber station.

US Published Patent Application 2006/0109856 of Deshpande describes an adaptive buffering scheme allowing more effective media transport and buffering. In one aspect of the adaptive buffering scheme, buffering parameters are adapted to different media characteristics, such as media play commands or the amount of encoding/transcoding required for the particular media stream. In another aspect of the adaptive buffering scheme, buffering is adapted to different transmission or memory conditions, such as transmission rate, packet jitter, or the amount of available buffer memory. In one example, the adaptive buffering is supported using Real Time Streaming Protocol (RTSP), and/or Real Time Transport Protocol (RTP) and associated Real Time Control Protocol (RTCP), and/or Session Description Protocol (SDP) messages.

The disclosures of all references mentioned above and throughout the present specification, as well as the disclosures of all references mentioned in those references, are hereby incorporated herein by reference.

### SUMMARY OF THE INVENTION

The present invention, in some exemplary embodiments thereof, seeks to provide a system and method for maintaining a substantially constant delay over changing transmission data rates in a point-to-point transmission.

An aspect of some exemplary embodiments of the present invention relates to a method for maintaining a substantially constant delay for point-to-point transmission of data.

Prior art point-to-point transmission receivers seeking to maintain substantially constant delay typically comprises a receiving buffer, sometimes termed a de jitter buffer. The prior art receiving buffer stores incoming data at a rate received by the receiver, and outputs data at a rate which may be temporarily different than the incoming data rate. The amount of content in the receiving buffer grows and shrinks over time, according to changes in the incoming data rate and the output data rate.

When a transmitter changes the transmission data rate, data flows into the receiving buffer at a different rate than flowing out. During such a time, the amount of data in the receiving buffer may change, and the size of the receiving buffer may grow or shrink. It is desired that the data passing through the receiving buffer which changes in size exit the receiving buffer at a fixed delay from the time the data was transmitted. Prior art efforts at controlling the delay by controlling the size of the receiving buffer are controlling a result of changing data rate, and typically not doing so accurately.

In an exemplary embodiment of the present invention, a transmitter transmits, in addition to data, an indication of what data rate is being transmitted. A receiver reads the indication of the data rate, and outputs data at the same rate the data was transmitted, thereby providing for a fixed delay. The receiver is configured to change a rate of output at exactly the right time, which is when the receiver starts to output data which was transmitted at the changed rate.

In an exemplary embodiment of the present invention, data is transmitted in data frames, with each data frame potentially being transmitted at a different data rate.

In an exemplary embodiment of the present invention, data is transmitted by radio transmission, using Adaptive Code Modulation (ACM). Changes in data rate are effected by changing the ACM constellation used for transmission from one data frame to another.

An exemplary embodiment of the present invention comprises a receiver with a receiving buffer. The receiving buffer receives data at a rate in which it has been transmitted by a transmitter, and outputs data at a rate controlled by an output rate controller. The receiver also comprises a reader for reading a transmission rate indicator from the data. When the transmission rate indicator reader reads a new transmission rate which is different than a current transmission rate, the transmission rate indicator reader provides the new information about the transmission rate to the output rate controller, and the output rate controller changes the rate of outputting data at a time coinciding with an output of the first data received at the new rate.

The term “transmission rate” in all its forms is used throughout the present specification and claims interchangeably with the term “transmission data rate” and the term “data rate” and their corresponding forms.

According to one aspect of the present invention there is provided a system configured to transmit data at a variable transmission rate over a point-to-point link, while maintaining a substantially constant transmission delay over the point-to-point link, including a transmitter configured to add an indication of a transmission rate to the data being transmitted and to transmit the indication of the transmission rate along with the data, and a receiver configured to receive an indication of a transmission rate along with data, to read the indication of the transmission rate, and including a delay compensation buffer.

Optionally the delay compensation buffer is configured to output the data at a rate based, at least partly, on the indication of the transmission rate.

Optionally the data being transmitted is included in frames.

Optionally, the indication of the transmission rate is included in frame headers included in the frames.

Optionally, each frame includes the indication of the transmission rate used for the transmission of the frame

Optionally, some of the frames do not include the indication of the transmission rate used for the transmission of the some of the frames.

Optionally, only initializing frames and first frames of a new transmission rate include the indication of the transmission rate used for the frames.

Optionally, the transmission over the point-to-point link includes Adaptive Code Modulation (ACM) transmission.

Optionally, the indication of the transmission rate includes an indication of an ACM constellation.

According to another aspect of the present invention there is provided a transmitter configured for maintaining a substantially constant transmission delay over a variable transmission rate point-to-point link, the transmitter configured to add an indication of a transmission rate to data being transmitted and to transmit the indication of the transmission rate along with the data.

According to yet another aspect of the present invention there is provided a receiver configured for maintaining a substantially constant transmission delay over a variable transmission rate point-to-point link, the receiver configured to receive an indication of a transmission rate along with data and to read the indication of the transmission rate, and including a delay compensation buffer configured to output the data at a rate based, at least partly, on the indication of the transmission rate.

According to another aspect of the present invention there is provided a method for maintaining a substantially constant transmission delay over a variable transmission rate point-to-point link including receiving an indication of a transmission rate along with data, reading the indication of the transmission rate, and outputting the data at a rate based, at least partly, on the indication of the transmission rate.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of exemplary embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of exemplary embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified flow chart of a method for maintaining substantially constant transmission delay over a point-to-point transmission;

FIG. 2 is a simplified block diagram of a system constructed and operative in accordance with an exemplary embodiment of the present invention;

FIG. 3 is a simplified illustration of data entering into and being output from a point-to-point transmission in the system of FIG. 2; and

FIG. 4 is another, more detailed, simplified block diagram of an alternative exemplary embodiment of the system of FIG. 2.

### DESCRIPTION OF PREFERRED EMBODIMENTS

The present embodiments comprise an apparatus and a method for maintaining a substantially constant delay in a point-to-point transmission.

The principles and operation of an apparatus and a method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

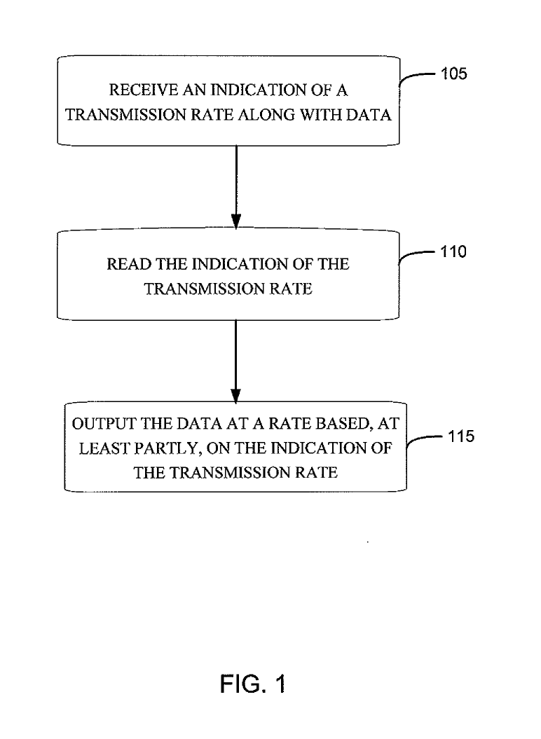

Reference is now made to FIG. 1, which is a simplified flow chart of a method for maintaining substantially constant transmission delay over a point-to-point transmission.

The method of FIG. 1 comprises receiving an indication of a transmission rate (step 105) along with data, reading the indication of the transmission rate (step 110), and forwarding the data at a rate based, at least partly, on the indication of the transmission rate (step 115).

The indication of the transmission rate which is used is an indication of the transmission rate actually used for transmission of the received data. That means that transmitted data should optionally be accompanied by an indication of the data rate at which it is transmitted, and at least whenever the transmission data rate changes, an indication of the new data rate should be transmitted along with the data.

In an exemplary embodiment of the present invention the indication of the transmission rate can be a specific bits-per-second number, and alternatively, the indication can be information known by both a transmitter and a receiver, the information being used to look up the transmission rate in a table of mutually-known transmission rates.

When the data and the indication of the transmission rate are received, the indication of the transmission rate is read, providing information as to what rate should be used for outputting received data, thereby defining the behavior of the elastic buffer.

Optionally, in some exemplary embodiments of the invention, the point-to-point transmission comprises a transmission of frames. Each frame may be sent at a different transmission rate. When each frame is sent at a different transmission rate, each frame optionally comprises the indication of the transmission rate used for sending.

In some exemplary embodiments of the present invention, the indication of the transmission rate is sent only in a first frame of a new transmission rate, or only in a first frame and every n-th subsequent frame.

In an exemplary embodiment of the present invention the indication of the transmission rate is included in the frame header.

One exemplary embodiment of the present invention comprises a transmission of data frames over a radio link, using Adaptive Code Modulation (ACM). When radio transmission conditions change, sometimes caused, for example, by changing weather conditions, an ACM constellation used for the radio transmission is optionally changed. An exemplary embodiment of the present invention which strives to maximize transmission data rate at all times, tracks the changing radio transmission conditions by changing ACM constellations, selecting an ACM constellation which maximizes transmission data rate at an acceptable error rate.

The transmission includes an indicator of the ACM constellation, whether explicitly, by specifying ACM parameters, or implicitly, by specifying some identifier, or code, which a receiver can associate with known parameters of the ACM constellation.

In order to specify an ACM constellation, each frame can carry the indicator of the ACM constellation. Alternatively, the indicator of the ACM constellation can be sent only once every few frames. Frames which are transmitted at an ACM constellation which has already been indicated do not need to carry the indicator of the ACM constellation, and the frames will be dealt with similarly to preceding frames which did carry the indicator of the ACM constellation.

In an exemplary embodiment of the present invention, the indicator of the ACM constellation can be sent only at initiation of the point-to-point transmission, and upon changing the ACM constellation. Frames sent without the indicator of the ACM constellation will be dealt with similarly to preceding frames which did carry the indicator of the ACM constellation.

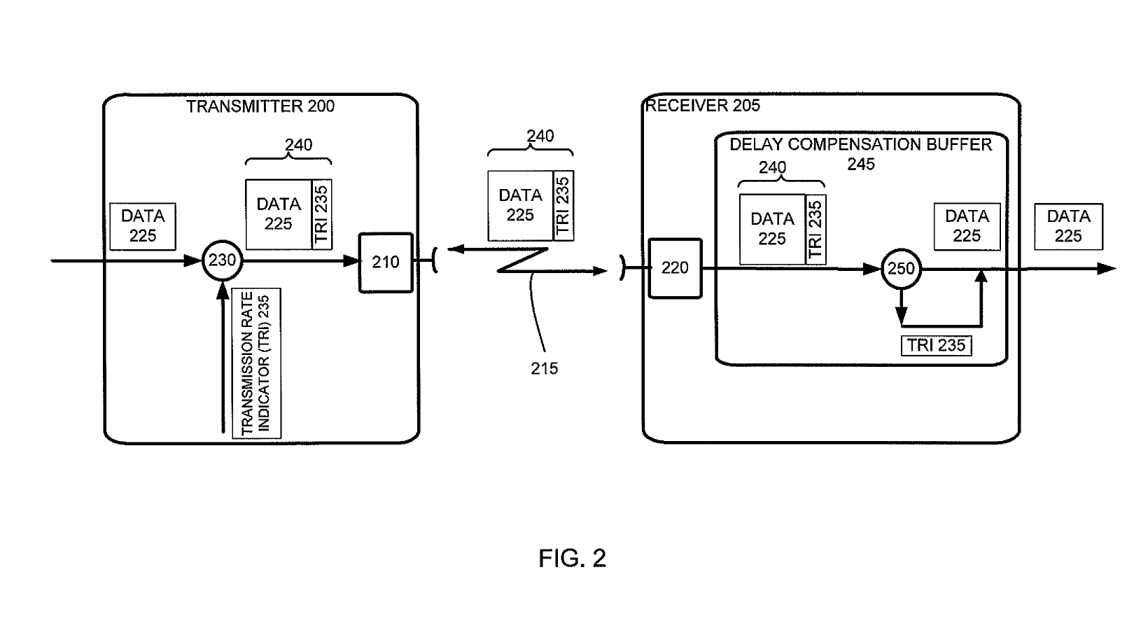

Reference is now made to FIG. 2, which is a simplified block diagram of a system constructed and operative in accordance with an exemplary embodiment of the present invention.

FIG. 2 depicts a transmitter 200 and a receiver 205. The transmitter 200 comprises a transmitting unit 210 for transmitting data and meta-data over a point-to-point radio transmission link 215 to a receiving unit 220 comprised in the receiver 205.

The transmitter 200 receives input of data 225, and contains a unit 230 for adding a Transmission Rate Indicator (TRI) 235 to the data 225. The output of the transmitter 200 is a frame 240 comprised of at least the data 225 and the TRI 235.

The frame 240 is transmitted via the transmitting unit 210, over the radio transmission link 215, to the receiving unit 220 in the receiver 205.

The receiver 205 passes the frame 240, comprising the data 225 and the TRI 235, to a delay compensation buffer 245. The receiver 205 also comprises a unit 250, which reads the TRI 235 in the received frame 240. The unit 250 provides the TRI 235 to the delay compensation buffer 245, which outputs the data 225 at an output rate based on the TRI 235.

It is to be appreciated that when a change is made to a new transmission rate, the delay compensation buffer 245 changes to a corresponding output data rate when starting to output data which was received at the new transmission rate.

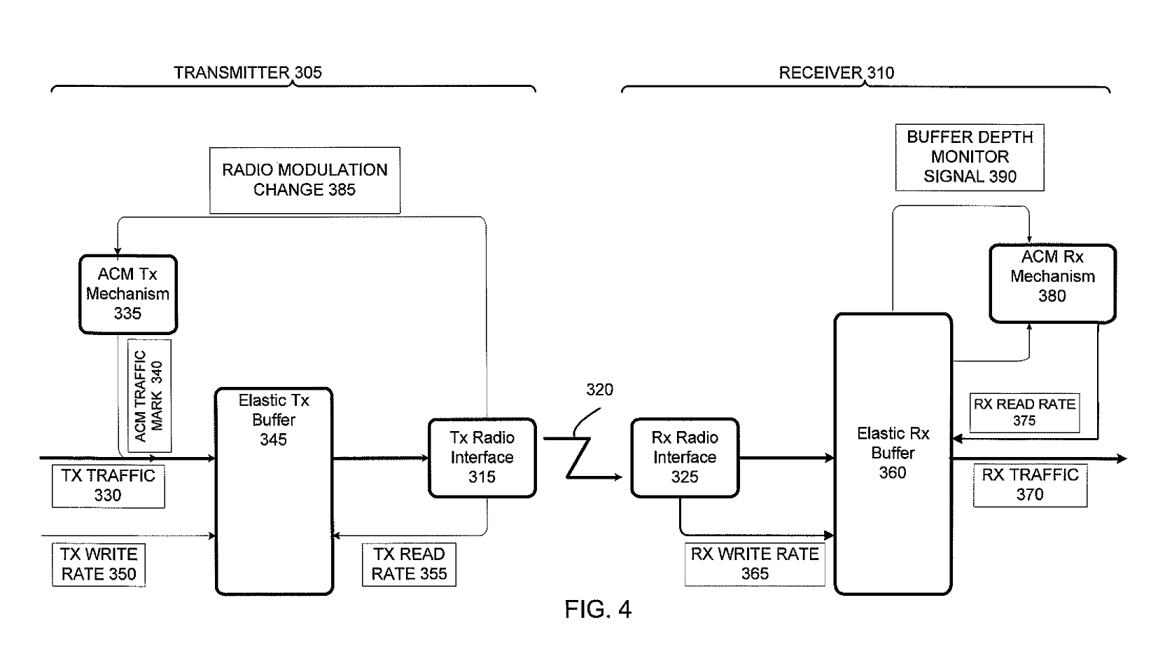

In an exemplary embodiment of the present invention the receiver 205 comprises a First-In-First-Out (FIFO) receiver buffer, used as the delay compensation buffer 245. It is to be appreciated that received data resides in the FIFO buffer for a period of time before being output. When a transmission data rate change occurs, new data is written into the FIFO buffer at the new transmission data rate, while old data is read from the FIFO buffer at an old transmission data rate. The output data rate changes at the moment the new data starts being output, as will be further described below with reference to FIG. 4.

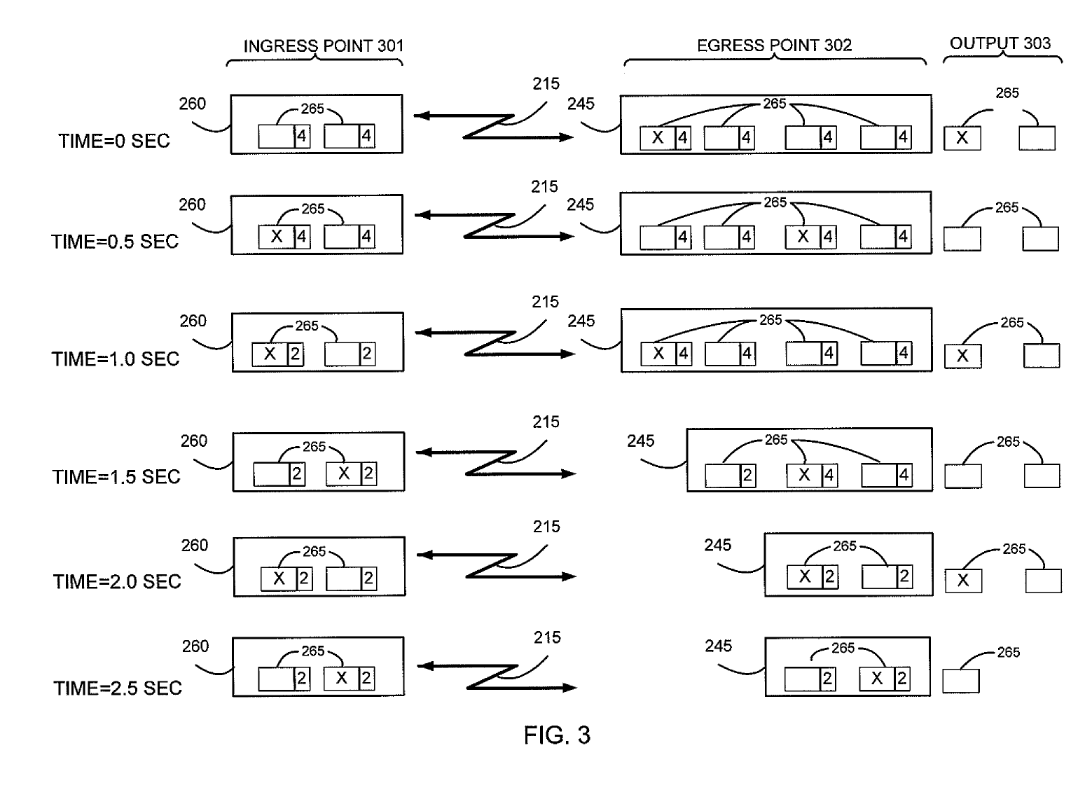

Reference is now made to FIG. 3, which is a simplified illustration of data entering into and being output from a point-to-point transmission in the system of FIG. 2.

The illustration depicts data frames 265 in an ingress point 301 of the point-to-point transmission, in a delay compensation buffer 245 on an egress point 302 of the point-to-point transmission, and being output 303 from the egress point 302.

The top row in FIG. 3, marked with TIME=0, depicts a transmission buffer 260 within the transmitter 200 of FIG. 2, containing the data frames 265 to be transmitted. The data frames 265 are transmitted over the point-to-point radio transmission link 215 of FIG. 2, to the delay compensation buffer 245 within the receiver 205 of FIG. 2, and the delay compensation buffer 245 outputs the data frames 265 in FIFO fashion.

Succeeding rows in FIG. 3, marked with TIME=0.5, TIME=1.0, to TIME=2.5, represent the objects depicted in the top row in FIG. 3, at successively later points in time.

A number is drawn within each data frame 265. The number indicates a data rate at which the data frames are transmitted, corresponding to the Transmission Rate Indicator (TRI) 235 of FIG. 2. The data frames having the number 4 are transmitted, by way of a non-limiting example, at 4 data frames per unit of time. By way of a non-limiting example, and for clarity of explanation, the unit of time is one second. The data frames having the number 2 are transmitted, by way of a non-limiting example, at 2 data frames per unit of time.

The data frames 265 which are drawn with an X inside represent a last data frame within a unit of time. The X represents a timestamp which is inserted into the data frames 265 every fixed and equal amount of time. It is to be appreciated that the timestamp is not necessary for the present invention to work, and is drawn herein so as to mark certain data frames, to assist in visualizing a group of data frames 265 passing through the system of FIG. 3.

Having laid out a context in which FIG. 3 is to be understood, the operation of the system of FIG. 3 will now be explained.

The top row, at TIME=0 seconds, depicts: two data frames in the transmission buffer 260, which are to be transmitted at a rate of 4 frames per second; four data frames in the receiving buffer which were transmitted and received at a rate of 4 data frames per second; and two data frames 265 which have been output by the delay compensation buffer 245, at a rate of 4 data frames per second, according to the method described above with reference to FIGS. 1 and 2.

0.5 seconds later, at TIME=0.5 seconds, as depicted by the second row in FIG. 3, two data frames 265 were transmitted from the transmitter 200 and received by the receiver 205, and an additional two more data frames 265 have been output by the delay compensation buffer 245, at the rate of 4 data frames per second.

0.5 seconds later, at TIME=1.0 seconds, as depicted by the third row in FIG. 3, two more data frames 265 were transmitted from the transmitter 200, at a rate of 4 data frames 265 per second, and received by the receiver 205, and an additional two more data frames 265 have been output by the delay compensation buffer 245. At this time the transmission buffer decides to change the transmission data rate from 4 frames per second to 2 frames per second. The frames within the transmission buffer 260 are now marked with the number 2, and the X marking appears once every two data frames 265.

0.5 seconds later, at TIME=1.5 seconds, as depicted by the fourth row in FIG. 3, one more data frame 265 was transmitted from the transmitter 200, at a new rate of 2 data frames per second, and received by the receiver 205. An additional two more data frames 265 have been output by the delay compensation buffer 245, at the old data rate of 4 frames per second. It is to be appreciated that the output data rate will not change until a data frame 265 marked with the number 2 is to be output.

0.5 seconds later, at TIME=2.0 seconds, as depicted by the fifth row in FIG. 3, one more data frame 265 was transmitted from the transmitter 200, at the new rate of 2 data frames 265 per second, and received by the receiver 205. An additional two more data frames 265 have been output by the delay compensation buffer 245, at the old data rate of 4 frames per second.

0.5 seconds later, at TIME=2.5 seconds, as depicted by the sixth row in FIG. 3, one more data frame 265 was transmitted from the transmitter 200, at the new rate of 2 data frames 265 per second, and received by the receiver 205. A data frame 265 has been output by the delay compensation buffer 245, at the new data rate of 2 frames per second. The change in output rate was prompted by the first data frame 265 with a transmission rate indication of 2 data frames per second reaching the output of the delay compensation buffer 245 in FIFO fashion. Only now, that the first data frame 265 with a different transmission rate indication arrives at an output side of the delay compensation buffer 245, does the output rate change, thereby ensuring that data is output from the delay compensation buffer 245 according to the transmission rate used for its transmission.

It is to be appreciated that the data frames 265 do not necessarily represent equal amounts of data, not even data frames which are marked with the same transmission rate. A delay time T spent by a unit, for example a bit, of data in the delay compensation buffer 245 is a result of an amount of data ahead of the unit in the FIFO buffer, being output at a rate R. If the size of the delay compensation buffer 245 is S, the time T can simply be S*R, or, if the delay compensation buffer 245 contains amounts of data S₁, S₂, S₃, and son, which were transmitted at different rates R₁, R₂, R₃, and so on, then the time T is: R₁*S₁+R₂*S₂+R₃*S₃, and so on. The time T is fixed, as will be further explained with reference to Equations 1-5 below.

It is to be appreciated that the number of data frames 265 depicted at any time in the transmission buffer 260 is intended purely as an example, and is not meant to limit the system of FIG. 3.

It is to be appreciated that the number of data frames 265 depicted in the delay compensation buffer 245 does display a behavior of the delay compensation buffer 245. At times when the transmission data rate changes, the delay compensation buffer 245 receives data at a different rate than the delay compensation buffer 245 outputs the data. When the transmission data rate changes to a higher transmission data rate, more data is received by the delay compensation buffer 245 than is output, and the delay compensation buffer 245 grows. When the transmission data rate changes to a lower transmission data rate, less data is received by the delay compensation buffer 245 than is output by the delay compensation buffer 245, and the delay compensation buffer 245 shrinks.

The delay compensation buffer 245 has a ratio between a minimum and a maximum size. Calculation of the ratio is described below with reference to Equations 1-5.

Optionally, a maximum size of the delay compensation buffer 245 can be calculated. In steady state operation there exist a transmission rate R₁, a delay compensation buffer 245 size S₁, and a time T₁ seconds which data spends from entering the delay compensation buffer 245 until being output from the delay compensation buffer 245. Equation 1 below describes the relation between R₁, S₁, and T₁ in a steady state:

$${T}_{1} = \frac{{S}_{1}}{{R}_{1}} \qquad Equation 1$$

When the transmission rate changes to R₂, it takes T₁ seconds for the first data which was received at the new rate to pass through the FIFO buffer, since all the older data is being output at the older rate. During that time an amount of data R₂*T₁ will have been added to the delay compensation buffer 245. The delay compensation buffer 245 size then changed gradually from S₁ to S₂=R₂*T₁. After this growth, data is output from the delay compensation buffer 245 at the same rate it is being received, and the delay compensation buffer 245 does not change size.

The old data received at the old transmission rate R₁ takes T₁ seconds to pass through the delay compensation buffer 245, since the output rate of the delay compensation buffer 245 is not affected by new data coming behind the old data in a FIFO.

The first data received at the new transmission rate R₂ takes T₁ seconds to pass through the delay compensation buffer 245, since that is how long it takes to output the old data, which is ahead of the new data in the FIFO, at the old data rate. Therefore the receiving buffer 245 new steady state size will be R₂*T₁.

Equation 2 below describes the relation between R₂, S₂, and T₂ in a new steady state with new transmission rate S₂:

$${T}_{2} = \frac{{S}_{2}}{{R}_{2}} \qquad Equation 2$$

Replacing S₂ with R₂*T₁ in Equation 3 below proves that T1=T2, which means that a constant delay is maintained by the system of FIG. 3.

$${T}_{2} = \frac{{S}_{2}}{{R}_{2}} = \frac{{R}_{2} * {T}_{1}}{{R}_{2}} = {T}_{1} \qquad Equation 3$$

Another way of writing Equation 1 and Equation 2 is as follows:

S₁=R₁*T₁ Equation 4

S₂=R₂*T₂ Equation 5

Since T₁=T₂, a size S of the delay compensation buffer 245 is proportional to the transmission data rate R. Having chosen a minimum size Sₘᵢₙ for the delay compensation buffer 245 to operate at a lowest transmission rate Rₘᵢₙ, it is to be appreciated that the buffer must be able to grow to a size Sₘₐₓ=Sₘᵢₙ*(Rₘₐₓ/Rₘᵢₙ) to support a maximum transmission rate Rₘₐₓ.

Reference is now made to FIG. 4, which is another, more detailed, simplified block diagram of an alternative exemplary embodiment of the system of FIG. 2.

FIG. 4 depicts a transmitter 305 and a receiver 310. The transmitter 305 comprises a transmission radio interface 315 for transmitting data and meta-data over a point-to-point radio transmission link 320 to a receiving radio interface 325 comprised in the receiver 310.

The transmitter 305 receives input of transmission traffic 330, typically comprising data frames. An ACM transmission mechanism 335 preferably adds an ACM traffic mark 340 to each frame.

The transmitter 305 also comprises an elastic transmission buffer 345, which is a FIFO buffer which accepts input of the transmission traffic 330 at various data rates. The data rates of the transmission traffic 330 are provided to the elastic transmission buffer 345 by a transmission write rate signal 350.

The elastic transmission buffer 345 outputs data for transmission to the transmission radio interface 315, at a rate suitable for transmission. The rate suitable for transmission is determined according to a transmission read rate signal 355, which is provided by the transmission radio interface 315, typically according to transmission conditions suitable for the point-to-point radio transmission link 320.

The transmission radio interface 315 transmits the data frames, and metadata such as the ACM traffic mark 340, using a suitable ACM constellation, to the receiving radio interface 325.

The receiving radio interface 325 writes the received data and metadata into an elastic receiving buffer 360, at a receiving write rate 365 indicated to the elastic receiving buffer 360 by the receiving radio interface 325. The elastic receiving buffer 360 is preferably a FIFO buffer.

The elastic receiving buffer 360 outputs data at a receiving read rate 375 which corresponds to the transmission read rate 355 which was in effect for the data presently being output by the elastic receiving buffer 360.

The receiving read rate 375 is provided to the elastic receiving buffer 360 by an ACM receiving mechanism 380, which reads the ACM traffic mark 340 which was transmitted along with the transmission traffic 330. The ACM receiving mechanism 380 specifies a suitable receiving read rate 375 based at least partly on reading the ACM traffic mark 340.

The ACM traffic mark 340 corresponds to the Transmission Rate Indicator (TRI) 235 of FIG. 2.

The ACM traffic mark 340 indicates the ACM constellation which was used in transmitting a data frame containing the ACM traffic mark 340. The indication of the ACM constellation may be explicit, by specifying ACM parameters, or implicit, by specifying some identifier, or code, which the ACM receiving mechanism 380 can associate with an ACM constellation, whose parameters are known to the ACM receiving mechanism 380.

It is to be appreciated that the transmission traffic 330 can be any data which requires transmission over a point-to-point radio transmission link 320. Some kinds of transmission traffic 330, such as, by way of a non-limiting example, SDH traffic, SONET traffic, and PDH traffic, greatly benefits from having a fixed delay.

The transmission radio interface 315 provides a radio modulation change message 385 to the ACM transmission mechanism 335, whenever an ACM constellation is going to change, based on an ACM constellation which the transmission radio interface 315 will use for transmission of the data and metadata. The radio modulation change message 385 indicates that a change of transmission rate is about to occur.

The ACM transmission mechanism 335 writes the ACM traffic mark 340 into the data frames.

The transmission radio interface 315 provides the elastic transmission buffer 345 with the transmission read rate 355 based on the same ACM constellation which the transmission radio interface 315 will use for transmission of the data and metadata.

The receiving radio interface 325 provides the elastic receiving buffer 360 with the receiving write rate 365 based on the ACM constellation which the transmission radio interface 325 uses for receiving the data and metadata.

The ACM receiving mechanism 380 provides the receiving read rate 375 to the elastic receiving buffer 360 based on the ACM traffic mark 340 which was transmitted along with the data.

By reading the ACM traffic mark 340, the receiving read rate 375 for output from the elastic receiving buffer 360 is set to be the same as the transmission read rate into the elastic transmission buffer 345, for the same data. Therefore one may understand the section from input to the elastic transmission buffer 345 to output from the elastic receiving buffer 360 as a buffer-like mechanism, which maintains the same output rate as input rate, for the same data, both during periods of fixed data rate transmission, and during a changing of the data rate.

It is to be appreciated that the receiving write rate 365 can be different from the receiving read rate 375. The rates can be different when the transmission rate changes, and the rates continue being different from the time first data arrives at the elastic receiving buffer 360 at a new transmission rate, until the first data is output from the elastic receiving buffer 360 at the new rate.

In an exemplary embodiment of the present invention, the ACM receiving mechanism 380 monitors a depth, or size, of the elastic receiving buffer 360, by receiving a buffer depth monitor signal 390. The monitoring is passive, that is, the depth of the elastic receiving buffer 360 is determined by input and output rates, and the monitoring measures the depth. The monitoring is used to monitor for potential problems, such as during initialization of the system of FIG. 2.

It is to be appreciated that the ACM traffic mark 340, which corresponds to the Transmission Rate Indicator (TRI) 235 in FIG. 2, can be any suitable identifier based upon which the ACM receiving mechanism 380 may identify a transmission rate. The ACM traffic mark 340 can explicitly specify the transmission rate, or the ACM traffic mark 340 can be an identifier which is used to look up a transmission rate in a table of suitable transmission rates.

It is to be appreciated that each ACM constellation is uniquely associated with a data transmission rate, and that different ACM constellations may, or may not, have different data transmission rates.

It is to be appreciated that the ACM traffic mark 340 is typically sent as data included in data frame headers.

It is to be appreciated that the ACM traffic mark 340 may not be included in every data frame. Alternative exemplary embodiments of the present invention require receiving the ACM traffic mark 340 only when a transmission data rate is changed.

Other alternative exemplary embodiments of the systems of FIGS. 2 and 3 above require receiving the ACM traffic mark 340 once every several data frames.

It is expected that during the life of this patent many relevant devices and systems will be developed and the scope of the terms herein, particularly of the terms frame, Adaptive Code Modulation (ACM), Adaptive Modulation and Coding (AMC), constellation, Time Division Multiplexing (TDM), E1, T1, PDH (Plesiochronous Digital Hierarchy), SONET, SDH (Synchronous Digital Hierarchy), radio, wireless, and point-to-point, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A system configured to transmit data at a variable transmission rate over a point-to-point link, while maintaining a substantially constant transmission delay during the course of data transmission over the point-to-point link, comprising:
a transmitter configured to transmit data at a variable transmission rate, to add an indication of the variable transmission rate to the data being transmitted, and to transmit the indication of the transmission rate along with the data; and
a receiver comprising a delay compensation buffer, configured to receive the indication of the transmission rate along with data, to read the indication of the transmission rate, and to output the data at a rate based, at least partly, on the indication of the transmission rate.

2. (canceled)

3. The system according to claim 1 and wherein the data being transmitted is comprised in frames.

4. The system according to claim 3 and wherein the indication of the transmission rate is comprised in frame headers comprised in the frames.

5. The system according to claim 3 and wherein each frame comprises the indication of the transmission rate used for the transmission of the frame.

6. The system according to claim 3 and wherein some of the frames do not comprise the indication of the transmission rate used for the transmission of the some of the frames.

7. The system according to claim 3 and wherein only initializing frames and first frames of a new transmission rate comprise the indication of the transmission rate used for the frames.

8. The system according to claim 1 and wherein the transmission over the point-to-point link comprises Adaptive Code Modulation (ACM) transmission.

9. The system according to claim 8 and wherein the indication of the transmission rate comprises an indication of an ACM constellation.

10. A transmitter configured for maintaining a substantially constant transmission delay during a course of data transmission over a variable transmission rate point-to-point link, the transmitter configured:
to transmit data at a variable transmission rate;
to add an indication of the variable transmission rate to data being transmitted; and
to transmit the indication of the variable transmission rate along with the data.

11. A receiver configured for maintaining a substantially constant transmission delay over a variable transmission rate point-to-point link, the receiver comprising a delay compensation buffer configured:
to receive an indication of the variable transmission rate along with data,
to read the indication of the variable transmission rate; and
to output the data at a rate based, at least partly, on the indication of the transmission rate.

12. A method for maintaining a substantially constant transmission delay over a variable transmission rate point-to-point link comprising:
adding an indication of the variable transmission rate to the data being transmitted;
transmitting the data and the indication at a variable transmission rate;
receiving the indication along with the data;
reading the indication; and
outputting the data at a rate based, at least partly, on the indication.
